(19) United States
(12) Patent Application Publication
(10) Pub. No.: US 2006/0104094 A1
(43) Pub. Date: May 18, 2006

(54) Back light assembly and display device having the same

(76) Inventors: Sang-Min Kang, Siheung-si (KR); Jeoung-Gwen Lee, Suwon-si (KR); Yong-Gwang Won, Yongin-si (KR); Sung-Yong Kang, Suwon-si (KR)

Correspondence Address: CANTOR COLBURN, LLP, 55 GRIFFIN ROAD SOUTH, BLOOMFIELD, CT, 06002, US

(21) Appl. No.: 11/234,027

(22) Filed: Sep. 23, 2005

(30) Foreign Application Priority Data
Nov. 16, 2004 (KR) 2004-93661

(51) Int. Cl. F21V 7/04

(52) U.S. Cl. 362/630

(57) ABSTRACT

A back light assembly comprises a light source, a power supply line, a receiving container, a fixing member and at least one connecting member. The light source generates light, and the power supply line supplies electrical power to the light source. The receiving container receives the light source. The fixing member is disposed on a rear face of the receiving container so as to attach the power supply line to the receiving container. The connecting member is disposed on the receiving container so as to couple the fixing member to the rear face of the receiving container. The power supply line may be firmly fixed to the receiving container so that a failure or a breakage of the power supply line may be prevented.

### CROSS-REFERENCE TO RELATED APPLICATION

This application claims priority under 35 USC § 119 to Korean Patent Application No. 2004-93661 filed on Nov. 16, 2004, the contents of which are herein incorporated by reference in its entirety.

### BACKGROUND OF THE INVENTION

1. Field of the Invention

The present invention relates to a display device for displaying images and a back light assembly for the display device. More particularly, the present invention relates to a back light assembly capable of decreasing a failure or a breakage of a power supply line and of firmly fixing a power supply line, and a display device having the back light assembly.

2. Description of the Related Art

In general, a liquid crystal display device (LCD) displays images using liquid crystal that has electrical and optical characteristics. That is, an alignment of molecules of the liquid crystal may vary in accordance with an electric field applied to the liquid crystal. In addition, light transmittance through the liquid crystal may vary in proportion to the alignment variation of the liquid crystal.

The LCD device generally includes a liquid crystal controlling member and a light providing member. The light providing member provides light to the liquid crystal, and the liquid crystal controlling member adjusts the molecular alignment of the liquid crystal.

The light providing member includes a light source for generating the light. For example, the light source comprises a cold cathode fluorescent lamp (CCFL), a light emitting diode (LED), a flat fluorescent lamp (FFL), etc.

The LCD device further includes a power supply line that supplies power to the light source, thereby generating the light from the light source. However, the power supply line of the LCD device may abnormally break or fail while using the LCD device. Additionally, since the power supply line includes a plurality of electrical wires, the power supply line may be complicated and may not be easily fixed. Although, the power supply line can be fixed using an adhesive tape, an adhesive resin may flow out from the adhesive tape to contaminate the LCD device. Further, since the adhesive tape may be easily broken or torn, the power supply line may not be properly fixed and also may be damaged when the adhesive tape is torn or broken.

### SUMMARY OF THE INVENTION

The present invention provides a back light assembly capable of firmly fixing a power supply line and of reducing a failure or a breakage of the power supply line.

The present invention provides a display device having the back light assembly.

In accordance with one aspect of the invention, there is provided a back light assembly comprising a light source, a power supply line, a receiving container, a fixing member and a connecting member. The light source generates light, and the power supply line supplies electrical power to the light source. The receiving container receives the light source. The receiving container comprises a bottom face. The fixing member fixes the power supply line to the receiving container. The connecting member is disposed on the receiving container. The connecting member couples the fixing member to a rear face of the receiving container.

The fixing member may comprise at least one fixing protrusion that protrudes from at least one side face of the fixing member. The protrusion may be coupled to the connecting member so as to fix the fixing member to the receiving container.

The connecting member may comprise a bracket structure to receive the fixing protrusion. The bracket structure may be formed by cutting a portion of the bottom face of the receiving container corresponding to the fixing protrusion.

The connecting member may comprise a first fixing portion and a second fixing portion extended from the first fixing portion. The first fixing portion may be substantially perpendicular to the rear face of the receiving container. The second fixing portion may substantially face the fixing protrusion.

An angle between the second fixing portion of the connecting member and the rear face of the receiving container may be substantially smaller than a right angle. For example, the angle is in the range of about 45° to about 85°.

The second fixing portion of the connecting member may comprise a protruding portion that protrudes toward the fixing protrusion, and the fixing protrusion of the fixing member may comprise an opening corresponding to the protruding portion of the second fixing portion.

The second fixing portion of the connecting member may comprise an opening and the fixing protrusion of the fixing member may comprise a protruding portion corresponding to the opening in the second fixing portion.

The fixing protrusion of the fixing member may comprise a rib to prevent the second fixing portion from being separated from the fixing protrusion.

The rear face of the receiving container may comprise an opening, and an area of the fixing protrusion of the fixing member may be substantially larger than that of the opening of the rear face so as to cover the opening of the rear face.

The fixing member may comprise two protrusions. One fixing protrusion may protrude from a first side face of the fixing member, and the other fixing protrusion may protrude from a second side face of the fixing member. The connecting member may comprise two bracket structures receiving the fixing protrusions of the fixing member, respectively.

The fixing member may comprise an engaging recess and the bottom face may comprise a first hole so that the fixing member and the rear face of the receiving container are combined with each other using a screw inserted into the engaging recess through the first hole. The light source may comprise a cover having a second hole corresponding to the first hole so that the cover is coupled to the bottom face using the screw passing through the second hole.

The fixing member may comprise a first face and a second face. The first face may make contact with the rear face of the receiving container. The second face may be substantially opposite to the first face. The second face may comprise at least one fixing groove to fix the power supply line to the receiving container.

The fixing member may comprise a separation preventing protrusion to prevent the power supply line from being separated from the fixing groove. The separation preventing protrusion may protrude from an inside of the fixing groove.

The connecting member may comprise at least one protrusion structure to fix the fixing member to the receiving container. The protrusion structure may protrude from the rear face of the receiving container.

The connecting member may comprise a pair of the protrusion structures respectively that protrude from the rear face of the receiving container. The protrusion structures may make contact with both side faces of the fixing member.

The fixing member may comprise a fixing protrusion that protrudes from the side face of the fixing member. The fixing protrusion may substantially face the protrusion structure. The fixing protrusion may comprise an opening corresponding to the protrusion structure.

The connecting member may comprise a first fixing portion and a second fixing portion. The first fixing portion may be formed by cutting a portion of the rear face of the receiving container. The second fixing portion may be formed by bending the cut portion of the rear face of the receiving container so as to grip the fixing member.

The connecting member may comprise two bracket structures disposed on corresponding side faces of the fixing member.

The connecting member may comprise two protrusion structures disposed on corresponding side faces of the fixing member.

The fixing member may comprise two fixing protrusions protruded from corresponding sidewalls of the fixing member. The connecting member may comprise a bracket structure and a protrusion structure. One fixing protrusion may be coupled to the bracket structure formed by cutting a portion of the rear face of the receiving container, and the other fixing protrusion having an opening may be coupled to the protrusion structure.

The rear face of the receiving container may comprise a coupling protrusion, and the fixing member may comprise an opening corresponding to the coupling protrusion of the rear face of the receiving container.

The rear face of the receiving container may comprise an opening, and the fixing member may comprise a coupling protrusion corresponding to the opening of the rear face of the receiving container.

The receiving container may comprise an inverter module including an inverter to apply a power to the power supply line. The rear face of the receiving container may comprise at least one boss to separate the inverter module from the rear face of the receiving container. The boss may comprise a protrusion to fix the inverter module to the bottom face of the receiving container, and the inverter module may comprise an opening corresponding to the protrusion of the boss. The inverter module may further comprise a shield case to absorb an electromagnetic wave generated from the inverter module. The shield case may comprise a bottom face and a sidewall, the bottom face of the shield case substantially facing the bottom face of the receiving container. The sidewall of the shield case may be disposed on a peripheral portion of the bottom face of the shield case and substantially perpendicular to the bottom face of the receiving container. An end portion of the sidewall of the shield case may be separated from the bottom face of the receiving container. The end portion of the sidewall of the shield case may be substantially facing the bottom face of the receiving container.

In accordance with another aspect of the invention, there is provided a display device including a back light assembly and a display panel. The back light assembly may comprise a light source to generate a light, a power supply line to apply a power to the light source, a receiving container having a bottom face to receive the light source, a fixing member to fix the power supply line to the receiving container and a connecting member disposed on the receiving container to couple the fixing member to a rear face of the receiving container. The display panel is received in the receiving container to display an image using the light.

According to the present invention, a power supply line may be firmly fixed to a rear face of a receiving container by employing a fixing member and a connecting member so that a failure or a breakage of the power supply line may be effectively prevented. Additionally, the power supply line may be easily attached to the receiving container without a short of the power supply line or damage to the power supply line.

### BRIEF DESCRIPTION OF THE DRAWINGS

The above and other advantages of the present invention will become readily apparent by reference to the following detailed description when considered in conjunction with the accompanying drawings wherein:

FIG. 1 is an exemplary embodiment of a rear perspective view illustrating a back light assembly in accordance with the present invention;

FIG. 2 is an exemplary embodiment of a partially cut rear plane view illustrating the back light assembly in FIG. 1;

FIG. 3 is an exemplary embodiment of a cross-sectional view illustrating the back light assembly taken along line of I-I′ in FIG. 2;

FIG. 4 is an exemplary embodiment of an enlarged perspective view illustrating a fixing member in accordance with the present invention;

FIG. 5 is an exemplary embodiment of an enlarged cross-sectional view illustrating the fixing member taken along line of II-II′ in FIG. 4;

FIG. 6 is an exemplary embodiment of enlarged perspective view illustrating portion “A” in FIG. 4;

FIG. 7 is an exemplary embodiment of an enlarged perspective view illustrating a connecting member in FIG. 4;

FIG. 8 is an exemplary embodiment of an enlarged cross-sectional view illustrating a fixing member and a connecting member of a back light assembly in accordance with the present invention;

FIG. 9 is another exemplary embodiment of an enlarged cross-sectional view illustrating a fixing member and a connecting member of a back light assembly in accordance with the present invention;

FIG. 10 is another exemplary embodiment of an enlarged cross-sectional view illustrating a fixing member and a connecting member of a back light assembly in accordance with the present invention;

FIG. 11 is a perspective view illustrating another exemplary embodiment of a back light assembly in accordance with the present invention;

FIG. 12 is an exemplary embodiment of an enlarged cross-sectional view illustrating a fixing member and a connecting member taken along line of III-III′ in FIG. 11;

FIG. 13 is another exemplary embodiment of a cross-sectional view illustrating a back light assembly in accordance with the present invention;

FIG. 14 is another exemplary embodiment of a perspective view illustrating a back light assembly in accordance with the present invention;

FIG. 15 is an exemplary embodiment of an enlarged cross-sectional view illustrating a fixing member and a connecting member taken along line of IV-IV′ in FIG. 14;

FIG. 16 is another exemplary embodiment of a perspective view illustrating a back light assembly in accordance with the present invention;

FIG. 17 is an exemplary embodiment of a cross-sectional view illustrating a fixing member and a connecting member taken along line of V-V′ in FIG. 16;

FIG. 18 is another exemplary embodiment of a perspective view illustrating a back light assembly in accordance with the present invention;

FIG. 19 is an exemplary embodiment of a cross-sectional view illustrating a fixing member and a connecting member taken along line of VI-VI′ in FIG. 18;

FIG. 20 is another exemplary embodiment of a perspective view illustrating a back light assembly in accordance with the present invention;

FIG. 21 is an exemplary embodiment of a cross-sectional view illustrating a fixing member and a connecting member taken along line of VII-VII′ in FIG. 20;

FIG. 22 is another exemplary embodiment of an exploded perspective view illustrating a back light assembly in accordance with the present invention;

FIG. 23 is an exemplary embodiment of a cross-sectional view illustrating an assembled back light assembly in accordance with the present invention;

FIG. 24 is another exemplary embodiment of a rear plan view illustrating a back light assembly in accordance with the present invention;

FIG. 25 is an exemplary embodiment of an enlarged cross-sectional view illustrating an assembled back light assembly in accordance with the present invention; and

FIG. 26 is an exemplary embodiment of an exploded perspective view illustrating a display device in accordance with the present invention.

### DETAILED DESCRIPTION OF THE INVENTION

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like reference numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the face through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A back light assembly of the present invention comprises a light source, a power supply line, a receiving container, a fixing member and a connecting member.

The light source generates light so that a display device including the back light assembly displays images using the light generated from the light source. The power supply line applies power to the light source so as to generate the light from the light source. The receiving container receives the light source. The fixing member is disposed on a rear face of the receiving container so that the fixing member fixes the power supply line on the rear face of the receiving container. The connecting member is used to attach the fixing member to the receiving container. The connecting member may be integrally formed with the receiving container. For example, the connecting member is formed by partially cutting and bending a rear portion of the receiving container.

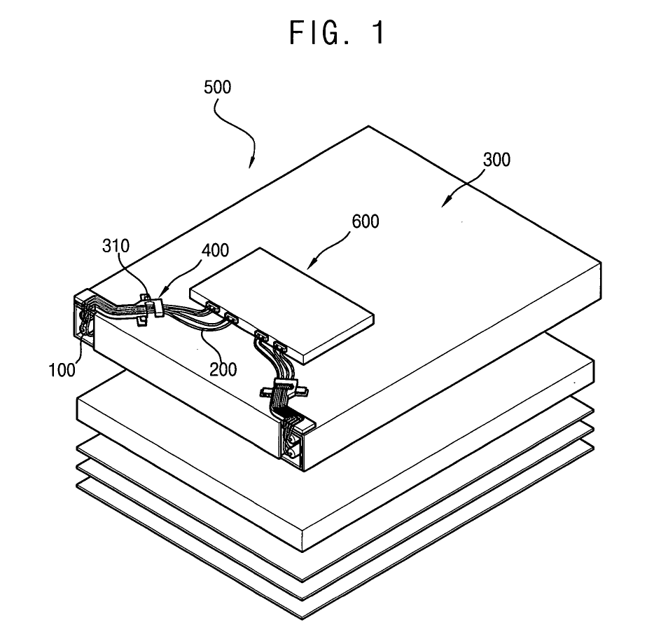

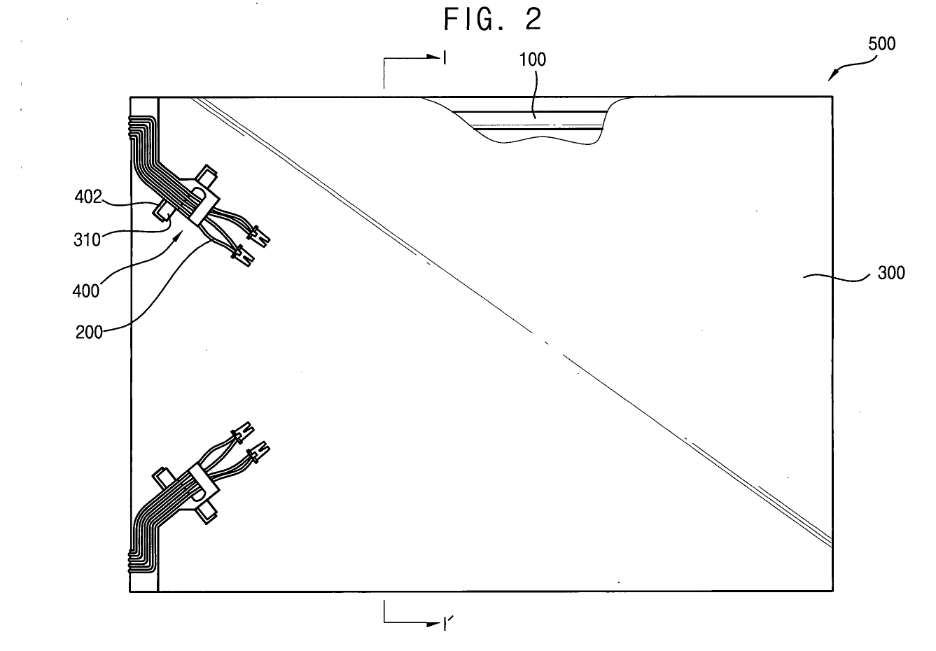

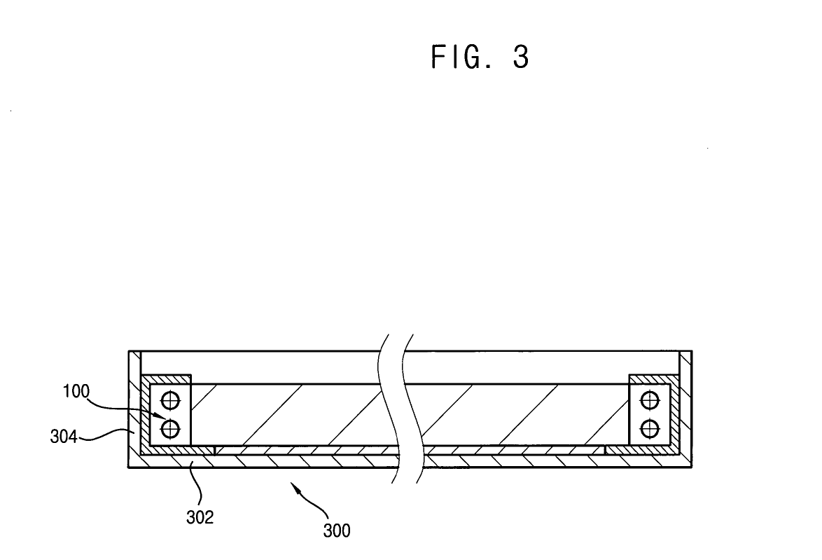

FIG. 1 is a rear perspective view illustrating a back light assembly in accordance with an exemplary embodiment the present invention. FIG. 2 is an exemplary embodiment of a partially cut rear plane view illustrating the back light assembly in FIG. 1. FIG. 3 is an exemplary embodiment of a cross-sectional view illustrating the back light assembly taken along line of I-I′ in FIG. 2.

Referring to FIGS. 1 to 3, a back light assembly 500 of the present embodiment includes a light source 100, a power supply line 200, a receiving container 300, a fixing member 400 and a connecting member 310.

The light source 100 may generate white light substantially similar to natural light in accordance with a discharge of a gas filled in the light source 100. In one embodiment, the light source 100 may include a cold cathode fluorescent lamp (CCFL). The CCFL may generate heat in an amount that is considerably lower than that generated by a conventional incandescent lamp. In another embodiment, the light source 100 may include a face light source or a light emitting diode.

The power supply line 200 applies power to the light source 100 so that the light source 100 generates light after the power is applied to the light source 100. The power supply line 200 may include a plurality of electrical wiring and a cover enclosing the electrical wirings. When the light source 100 includes the CCFL, the power supply line 200 may be connected to electrodes disposed at both end portions of the CCFL.

The receiving container 300 receives the light source 100 as shown in the FIG. 3. The receiving container 300 includes a bottom face 302 and sidewalls 304. The receiving container 300 may be in the shape of a rectangular box having an upper face that is open. The bottom face 302 of the receiving container 300 may have a rectangular plate-like shape. In one embodiment, the sidewalls 304 of the receiving container 300 are extended from a peripheral portion of the bottom face 302 in a direction substantially perpendicular to the bottom face 302. Therefore, the receiving container 300 provides a receiving space defined by the bottom face 302 and the sidewalls 304.

At least one light source 100 may be disposed adjacent to the sidewalls 304 of the receiving container 300. For example, one light source 100 may be disposed adjacent to one of the sidewalls 304 of the receiving container 300. Alternatively, at least two light sources 100 may be disposed adjacent to corresponding sidewalls 304 of the receiving container 300, respectively. In another embodiment, at least three light sources 100 may be disposed adjacent to corresponding sidewalls 304 of the receiving container 300, respectively.

In the present embodiment, four light sources 100 are disposed adjacent to the sidewalls 304 of the receiving container 300. Here, two light sources 100 are adjacent to one of the sidewalls 304 of the receiving container 300 by a predetermined interval, and two light sources 100 are positioned near another of the sidewalls 304 of the receiving container 300 by the predetermined interval. In one embodiment, the light sources 100 are disposed to face one another.

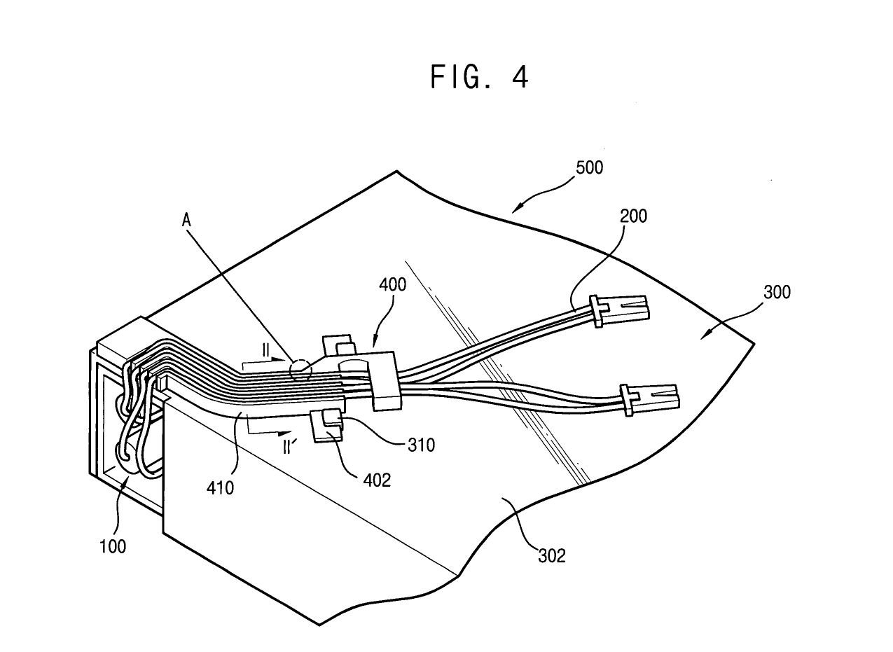

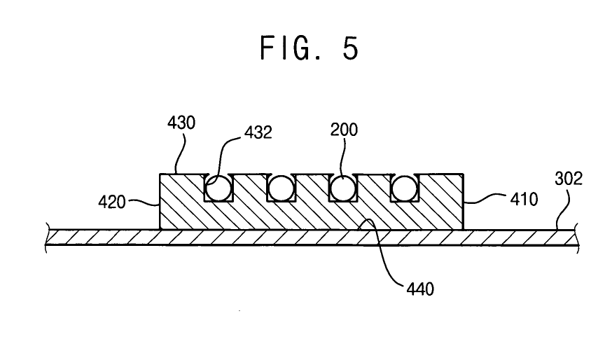

FIG. 4 is an exemplary enlarged perspective view illustrating the fixing member 400 in accordance with the present invention, and FIG. 5 is an exemplary embodiment of an enlarged cross-sectional view illustrating the fixing member 400 taken along line of II-II′ in FIG. 4.

Referring to FIGS. 4 and 5, the fixing member 400 is disposed on the rear face of the receiving container 300. The fixing member 400 is used to attach the power supply line 200 on the rear face of the receiving container 300. Here, the power supply line 200 is electrically connected to the light sources 100 as described above.

The fixing member 400 may be formed using a synthetic resin. The fixing member 400 may have a substantially rectangular structure. The fixing member 400 includes a first face 440, a second face 430, a first side face 410 and a second side face 420. The first face 440 of the fixing member 400 makes contact with the bottom face 302 of the receiving container 300. The second face 430 is substantially opposed to the first face 440. The first and the second side faces 410 and 420 connect the first face 440 to the second face 430.

The fixing member 400 further includes at least one fixing protrusion 402 that protrudes from the first side face 410 and/or the second side face 420. The fixing protrusion 402 may have a plate-like shape. The fixing protrusion 402 may have a thickness that is substantially thinner than that of the first side face 410 and/or the second side face 420. In the present embodiment, two fixing protrusions 402 protrude from the first side face 410 and the second side face 420, respectively. The fixing protrusions 402 of the fixing member 400 may be extended in parallel to the bottom face 302 of the receiving container 300.

As shown in FIG. 5, the fixing member 400 includes at least one fixing groove 432 or at least one fixing recess in an upper portion of the second face 430. For example, four fixing grooves 432 or fixing recesses are formed in the upper portion of the second face 430. The power supply line 200 including the electrical wires is fixed in position by disposing it in the fixing groove 432. At least one electrical wire of the power supply line 200 is disposed in a single fixing groove 432. In one embodiment, two or more electrical wires of the power supply line 200 are disposed in a single fixing groove 432. The fixing groove 432 may have a rectangular shape. Alternatively, the fixing groove 432 may have a serpentine shape to prevent the power supply line 200 from being broken or damaged when an external tension or impact is applied to the power supply line 200.

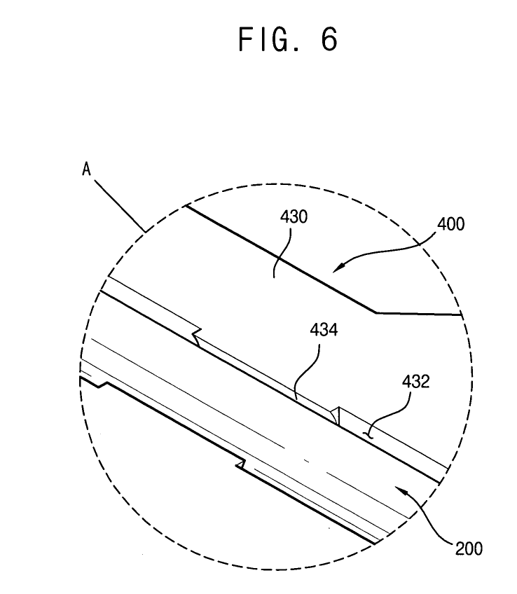

FIG. 6 is an enlarged perspective view illustrating portion “A” in FIG. 4.

Referring to FIGS. 4 and 6, the fixing member 400 may further include at least one separation preventing protrusion 434 that protrudes from an inside of the fixing groove 432. The power supply line 200 is fixed in the inside of the fixing groove 432. The separation preventing protrusions 434 prevents a separation of the power supply line 200 from the second face 430 of the fixing member 400. At least one separation preventing protrusion 434 is disposed on the inside of the fixing groove 432. For example, more than two separation preventing protrusions 434 may protrude from the inside of the fixing groove 432. Here, the separation preventing protrusions 434 may be separated from each other by a predetermined distance so as to receive the power supply line 200 in the fixing groove 432.

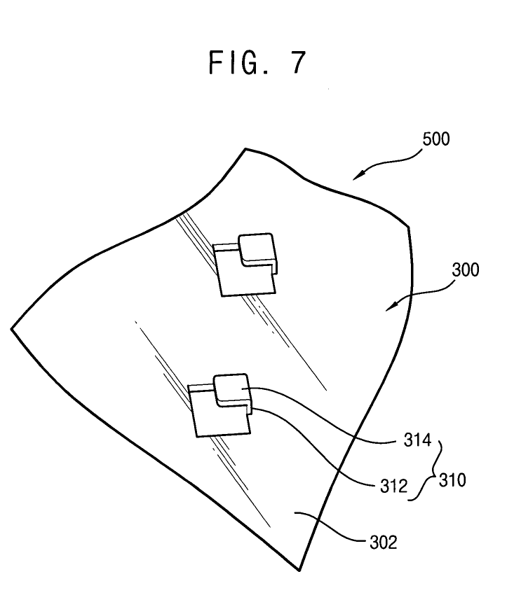

FIG. 7 is an enlarged perspective view illustrating the connecting member 310 in FIG. 4.

Referring to FIGS. 4 and 7, the fixing protrusions 402 of the fixing member 400 are protruded in a direction that is substantially parallel to the bottom face 302 of the receiving container 300. The fixing protrusions 402 are combined with the connecting member 310. Thus, the fixing member 400 is fixed to the bottom face 302 of the receiving container 300 by means of the fixing protrusions 402 and the connecting member 310.

In one embodiment, the connecting member 310 may be integrally formed with the bottom face 302 of the receiving container 300. In the present embodiment, the connecting member 310 includes two bracket structures corresponding to the fixing protrusions 402 of the fixing member 400. The bracket structures of the connecting member 310 are disposed at portions of the bottom face 302 corresponding to the fixing protrusions 402, both of which protrude from the first and second side faces 410 and 420, respectively.

Each of the bracket structures of the connecting member 310 includes a first fixing portion 312 and a second fixing portion 314. The first and second fixing portions 312 and 314 may be formed by partially cutting the bottom face 302 of the receiving container 300, and then by partially bending the cut portion of the bottom face 302. The first fixing portion 312 may be extended substantially perpendicular to the bottom face 302. The second fixing portion 314 may be extended substantially parallel to the bottom face 302. In the present embodiment, the second fixing portion 314 is bent along a direction to which the fixing protrusion 402 of the fixing member 400 is coupled to the bracket structure of the connecting member 310.

Since the bracket structure of the connecting member 310 is formed by cutting and bending a portion of the bottom face 302 of the receiving container 300, an opening is formed through the bottom face 302. The opening in the bottom face 302 may have a rectangular shape. When the opening is formed in the bottom face 302, particles or impurities may enter into the receiving container 300 through the opening in the bottom face 302. In order to prevent the particles or impurities from entering into the receiving container 300, the area of the fixing protrusion 402 of the fixing member 400 may be substantially larger than that of the opening of the bottom face 302. As described above, the fixing protrusions 402 of the fixing member 400 are respectively inserted in the bracket structures of the connecting member 310 so that the power supply line 200 received in the fixing member 400 may be more firmly fixed to the bottom face 302 of the receiving container 300.

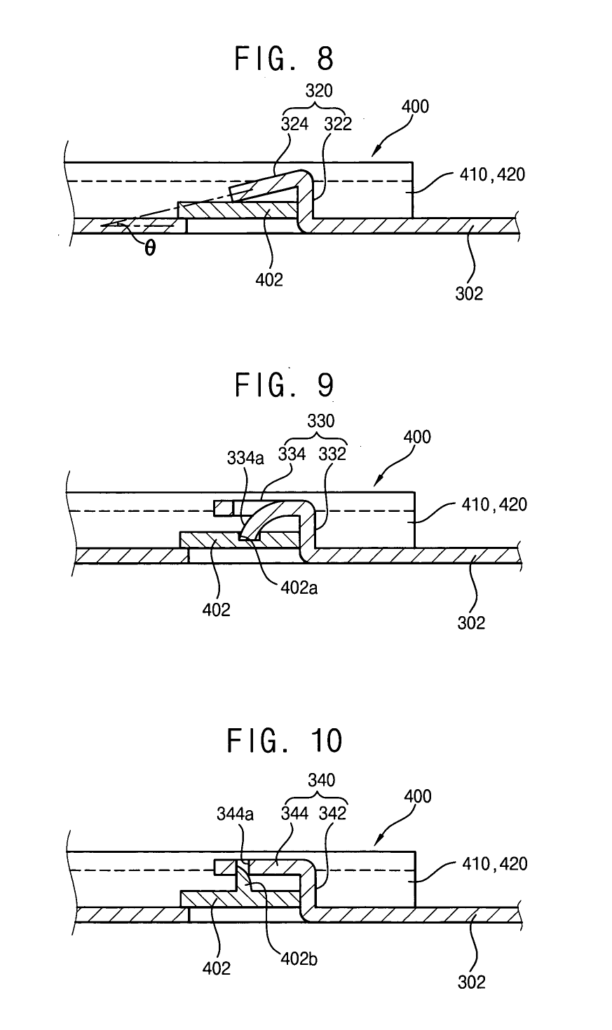

FIG. 8 is an exemplary enlarged cross-sectional view illustrating a fixing member and a connecting member of a back light assembly in accordance with the present invention. The back light assembly of the present embodiment has a construction substantially similar to that of the back light assembly according to the first embodiment except for the presence of a connecting member 320.

Referring to FIG. 8, the connecting member 320 of the present embodiment may also include at least one bracket structure. The bracket structure of the connecting member 320 is disposed on a portion of the bottom face 302 of the receiving container corresponding to the fixing protrusion 402 of the fixing member 400. As described above, at least one fixing protrusion 402 protrudes from the first side face 410 or the second side face 420 of the fixing member 400. The connecting member 320 may be integrally formed with the bottom face 302 of the receiving container

The bracket structure of the connecting member 320 has a first fixing portion 322 and a second fixing portion 324. The bottom face 302 is partially cut and then bent to thereby form the first fixing portion 322 and the second fixing portion 324 that is extended from the first fixing portion 322. In one embodiment, the first fixing portion 322 may be substantially perpendicular to the bottom face 302. The second fixing portion 324 is extended from the first fixing portion 322 toward the fixing protrusion 402. The second fixing portion 324 may be disposed along a direction to which the fixing protrusion 402 of the fixing member 400 is inserted.

In the present embodiment, the second fixing portion 324 is bent from the first fixing portion 322 to press an end of the fixing protrusion 402. Therefore, an angle θ between the second fixing portion 324 and the bottom face 302 may be smaller than a right angle. For example, the angle θ between the second fixing portion 324 and a line drawn parallel to the bottom face 302 is in a range of about 45° to about 85°. When the angle θ between the second fixing portion 324 and the bottom face 302 is substantially smaller than the right angle, the second fixing portion 324 may make contact an upper face of the fixing protrusion 402 or be separated from the upper face of the fixing protrusion 402 by a predetermined interval.

The fixing protrusion 402 of the fixing member 400 is inserted in the bracket structure of the connecting member 320 so that a power supply line 200 may be firmly fixed to the bottom face 302 of the receiving container.

FIG. 9 is an enlarged cross-sectional view illustrating another exemplary embodiment of a fixing member and a connecting member of a back light assembly in accordance with a third embodiment of the present invention. The back light assembly of the present embodiment has a construction substantially similar to that of the back light assembly according to the first embodiment except for a connecting member 330.

Referring to FIG. 9, the connecting member 330 also includes a bracket structure. The bracket structure of the connecting member 330 is disposed on the bottom face 302 of the receiving container. In other words, the bracket structure is manufactured from a portion of the bottom face 302 of the receiving container. In particular, the connecting member 330 is positioned on the bottom face 302 corresponding to a fixing protrusion 402 of a fixing member 400. At least one fixing protrusion 402 protrudes from a first side face 410 and/or a second side face 420 as described above. The connecting member 330 may be integrally formed with the bottom face 302 of the receiving container.

The bracket structure of the connecting member 330 has a first fixing portion 322 and a second fixing portion 334. The first fixing portion 322 and a second fixing portion 334 are formed by cutting a portion of the bottom face 302 and then by partially bending the cut portion of the bottom face 302. The first fixing portion 332 may be substantially perpendicular to the bottom face 302. The second fixing portion 334 may be disposed along a direction where the fixing protrusion 402 of the fixing member 400 is inserted.

To prevent a separation of the fixing protrusion 402 of the fixing member 400 from the connecting member 330, the second fixing portion 334 includes a protruding portion 334a and the fixing protrusion 402 has an opening 402a or a recess. The protruding portion 334a of the second fixing portion 334 may be bent toward the fixing protrusion 402. The opening 402a of the fixing protrusion 402 receives the protruding portion 334a of the second fixing portion 334. That is, an end of the protruding portion 334a of the second fixing portion 334 is inserted into the opening 402a of the fixing protrusion 402 so that the fixing protrusion 402 is fixed to the second fixing portion 334 of the connecting member 330. The protruding portion 334a of the second fixing portion 334 may be formed by partially cutting the second fixing portion 334.

When the protruding portion 334a is inserted into the opening 402a as depicted in the FIG. 9, the fixing member 400 will be firmly fixed to the receiving container.

FIG. 10 is an enlarged cross-sectional view illustrating another exemplary embodiment of a fixing member and a connecting member of the back light assembly in accordance with the present invention. The back light assembly of the present embodiment has a construction substantially similar to that of the back light assembly according to the first embodiment except for the presence of a connecting member 340.

Referring to FIG. 10, the connecting member 340 of the present embodiment also includes a bracket structure. The bracket structure of the connecting member 340 is disposed on the bottom face 302 of the receiving container. In other words, the bracket structure is manufactured from a portion of the bottom face 302 of the receiving container. In particular, the bracket structure of the connecting member 340 is positioned on the bottom face 302 corresponding to a fixing protrusion 402 of the fixing member 400. As described above, at least one fixing protrusion 402 protrudes from a first side face 410 and/or a second side face 420. The connecting member 340 may be integrally formed with the bottom face 302 of the receiving container.

The bracket structure of the connecting member 340 includes a first fixing portion 342 and a second fixing portion 344. A portion of the bottom face 302 of the receiving container is cut and then bent to thereby form the first fixing portion 342 and the second fixing portion 344. In one embodiment, the first fixing portion 342 may be substantially perpendicular to the bottom face 302 as shown in the FIG. 10. In another embodiment, the first fixing portion is not substantially perpendicular (not shown) to the bottom face 302. The second fixing portion 344 extends from the first fixing portion 342 so that the second fixing portion 344 may be substantially parallel to the bottom face 302 of the receiving container. The second fixing portion 344 of the connecting member 340 may be extended along a direction where the fixing protrusion 402 of the fixing member 400 is inserted.

In the present embodiment, the fixing protrusion 402 has a protruding portion 402b and the second fixing portion 344 includes an opening 344a or a hole so as to prevent a separation of the fixing protrusion 402 from the connecting member 340. The protruding portion 402b of the fixing protrusion 402 may be extended toward the second fixing portion 344. An end of the protruding portion 402b of the fixing protrusion 402 is inserted into the opening 344a of the second fixing portion 344. In one embodiment, the opening 344a may extend through the entire cross-sectional area of the second fixing portion 344. In another embodiment, the opening 344a may extend only through a portion of the cross-sectional area of the second fixing portion 344. Thus, the fixing protrusion 402 is firmly fixed to the second fixing portion 344 of the connecting member 340.

When the protruding portion 402b is inserted into the opening 344a the fixing member 400 is firmly fixed to the receiving container.

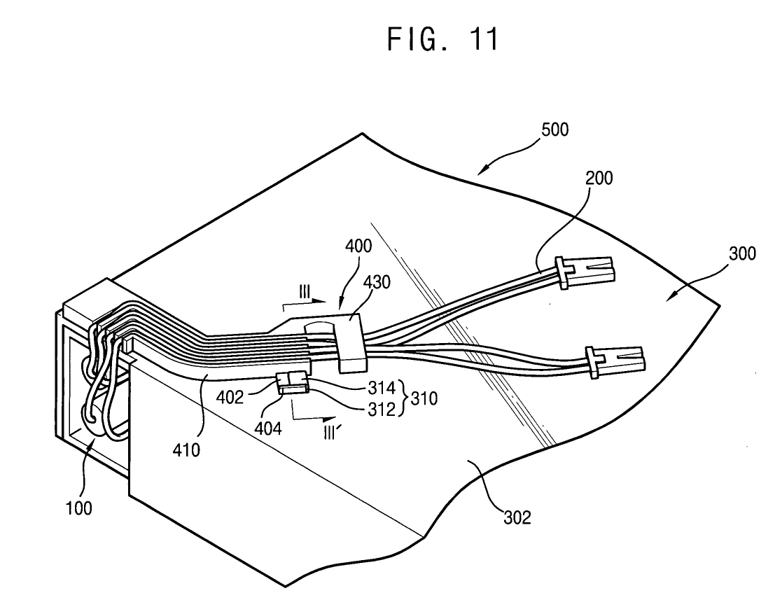

FIG. 11 is a perspective view illustrating another exemplary embodiment of a fixing member and a connecting member of a back light assembly in accordance with the present invention. FIG. 12 is an enlarged cross-sectional view illustrating the fixing member and the connecting member taken along line III-III′ in FIG. 11. The back light assembly of the present embodiment has a construction substantially similar to that of the back light assembly according to the first embodiment except for the presence of a fixing member 400.

Referring to FIGS. 11 and 12, the fixing member 400 of the present invention is disposed on a rear face of a receiving container 300. The fixing member 400 fixes the power supply line 200 to the rear face of the receiving container 300. The power supply line 200 including the electrical wires is electrically connected to a light source 100.

The fixing member 400 may be manufactured from a synthetic resin. A suitable synthetic resin is one that is electrically insulating. Suitable synthetic resins may be thermoplastic resins or thermosetting resins. Examples of suitable thermoplastic synthetic resins are polyolefins, polyamides, polycarbonates, polyesters, polyimides, polyacrylates, polymethacrylates, polyurethanes, or the like, or a combination comprising at least one of the foregoing thermoplastic synthetic resins. Examples of suitable thermosetting resins are polysiloxanes, epoxies, phenolic resins, polyurethanes, or the like, or a combination comprising at least one of the foregoing thermosetting synthetic resins.

In one embodiment, filled synthetic resins can be used for manufacturing the fixing member 400. Exemplary fillers are glass fibers, carbon fibers, nanotubes, titanium dioxide, mica, clay, or the like, or a combination comprising at least one of the foregoing fillers.

The fixing member 400 can be manufactured via extrusion and molding. Suitable extruders used for the manufacturing process are single and/or twin screw extruders. Suitable forms of molding are compression molding, extrusion molding, injection molding, or the like, or a combination comprising at least one of the foregoing molding processes.

The fixing member 400 may have a rectangular shape. The fixing member 400 includes a first face 440, a second face 430, a first side face 410 and a second side face 420. The first face 440 contacts the rear face of the receiving container 300. The second face 430 is substantially opposed to the first face 440. The first and the second side faces 410 and 420 connect the first face 440 to the second face 430.

At least one fixing protrusion 402 protrudes from the first side face 410 and/or the second side face 420. The fixing protrusion 402 may have a plate-like shape and may have a thickness substantially thinner than that of the first side face 410. For example, the two fixing protrusions 402 protrude from the first and the second side faces 410 and 420, respectively. The fixing member 400 further includes at least one fixing groove 432 or fixing recess formed in an upper portion of the second face 430. For example, four fixing grooves 432 or fixing recesses are formed in the upper portion of the second face 430. The power supply line 200 including the electrical wires is fixed in the fixing groove 432 of the fixing member 400. In one embodiment, the fixing groove 432 may have a rectangular shape. In another embodiment, the fixing groove 432 may have a serpentine shape to prevent the power supply line 200 from being damaged when an external tension or impact is applied to the power supply line 200.

The fixing protrusion 402 is coupled to a connecting member 310 including a bracket structure. The bracket structure of the connecting member 310 includes a first fixing portion 312 and a second fixing portion 314. The fixing protrusion 402 includes a rib 404 to prevent a separation of the fixing protrusion 402 from the connecting member 310. The rib 404 may be perpendicularly extended from an upper face of the fixing protrusion 402.

When the fixing protrusion 402 includes the rib 404, the fixing member 400 may be firmly fixed on the rear face of the receiving container 300.

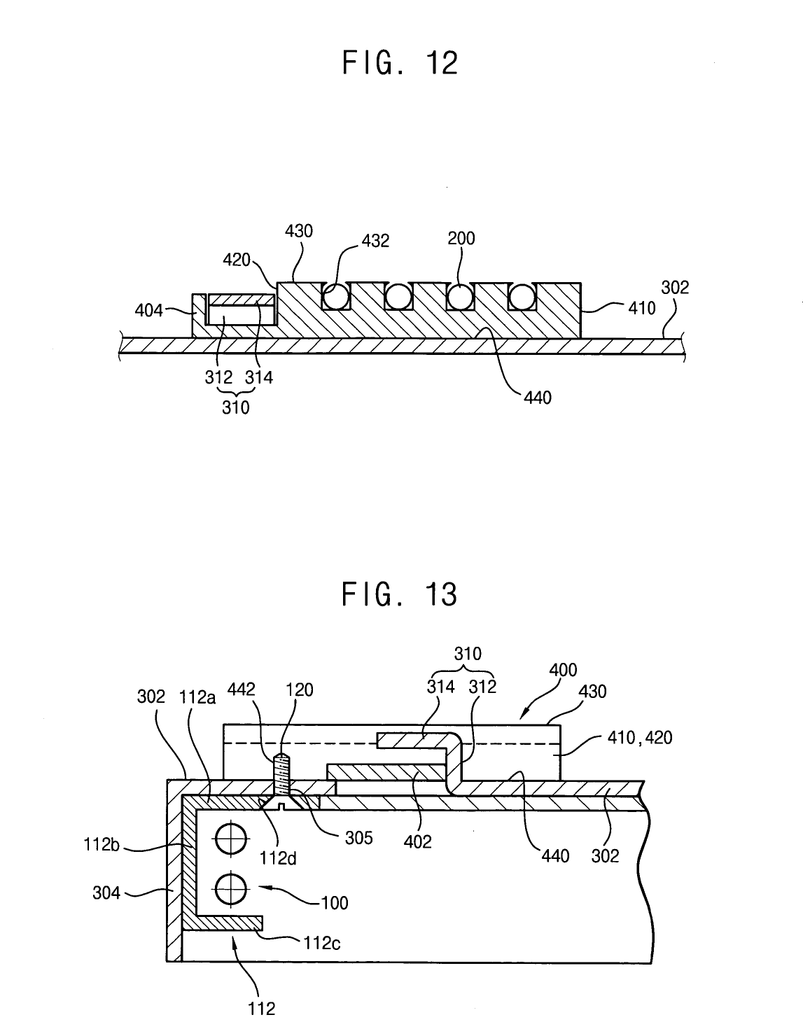

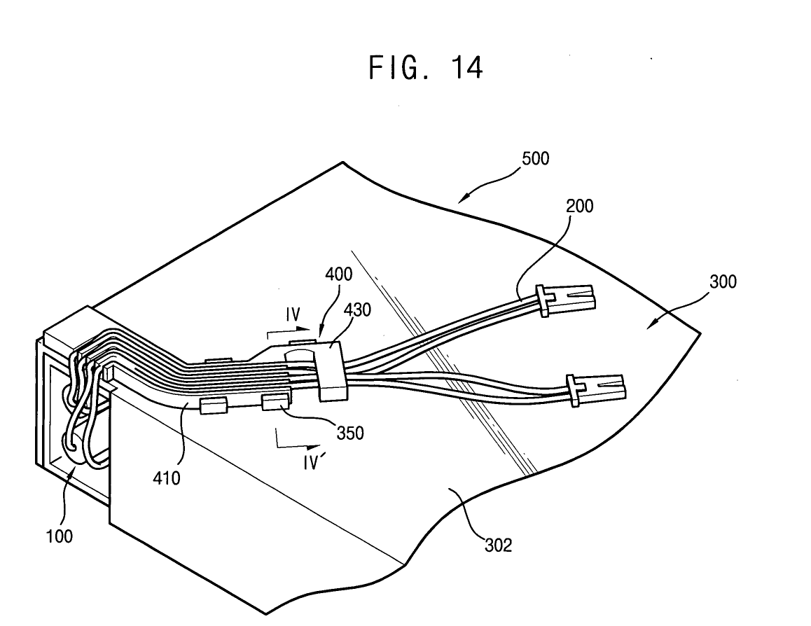

FIG. 13 is a cross-sectional view illustrating another exemplary embodiment of a back light assembly in accordance with the present invention. The back light assembly of the present embodiment has a construction substantially similar to that of the back light assembly according to the first embodiment except for the pressence of a fixing member 400 and a coupling structure on the receiving container.

Referring to FIG. 13, the fixing member 400 of the present invention is fixed to a rear face of a receiving container by means of the fixing protrusion 402 and the connecting member 310 that has a bracket structure. The bracket structure of the connecting member 310 is disposed on the bottom face 302 of the receiving container. However, in this embodiment, the fixing protrusion 402 of the fixing member 400 may be separated from the connecting member 310 when a vibration or impact is applied to the fixing member 400. In order to prevent such separation, the fixing member 400 is connected with the bottom face 302 of the receiving container using a screw 120 in order to effectively prevent a separation of the fixing protrusion 402 from the connecting member 310.

The first face 440 of the fixing member 400 has an engaging recess 442 or an engaging groove that faces the bottom face 302 of the receiving container. The bottom face 302 includes a first hole 305 corresponding to the engaging recess 442. Thus, the fixing member 400 is firmly coupled to the bottom face 302 of the receiving container by inserting the screw 120 into the engaging recess 442 through the first hole 305.

In the present embodiment, a light source 100 may include a cover 112 that collects light radiating in all directions from the light source 100. The cover 112 includes a first face 112a, a second face 112b and a third face 112c. The first face 112a of the cover 112 contacts the bottom face 302 of the receiving container. The second face 112b of the cover 112 contacts the sidewalls 304 of the receiving container. The third face 112c of the cover 112 is substantially opposed to the first face 112a of the cover 112.

The first face 112a of the cover 112 includes a second hole 112d corresponding to the first hole 305 of the bottom face 302. Therefore, the cover 112, the bottom face 302 and the fixing member 400 are firmly connected with one another by means of the screw 120. That is, the screw 120 is inserted into the engaging recess 442 through the second hole 112d and the first hole 305 so that the cover 112, the bottom face 302 and the fixing member 400 are coupled to one another.

According to the present embodiment, the fixing member 400 may be firmly fixed on the rear face of the receiving container 300 using the screw 120, the fixing protrusion 402 and the connecting member 310.

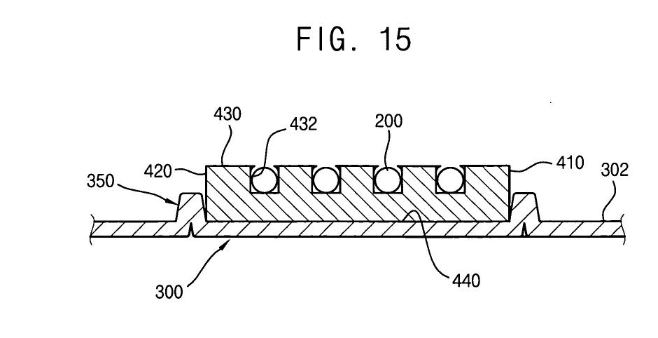

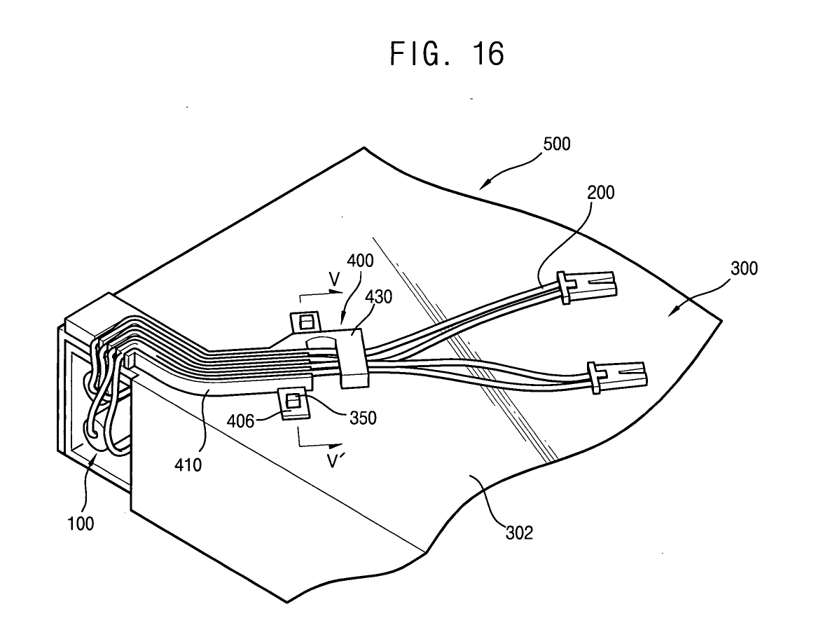

FIG. 14 is a perspective view illustrating another exemplary embodiment of a fixing member and a connecting member of a back light assembly in accordance with the present invention. FIG. 15 is an enlarged cross-sectional view illustrating the fixing member and the connecting member taken along line IV-IV′ in FIG. 14. The back light assembly of the present embodiment has a construction substantially similar to that of the back light assembly according to the first embodiment except for the presence of a connecting member 350.

Referring to FIGS. 14 and 15, the fixing member 400 is disposed on the bottom face 302 of the receiving container 300. The connecting member 350 includes two protrusion structures disposed on the bottom face 302 so that the fixing member 400 may not be separated from the bottom face 302 of the receiving container 300. The protrusion structures of the connecting members 350 contact a first side face 410 and a second side face 420 of the fixing member 400, respectively. As shown in the FIG. 15, the protrusion structures have inverted V shapes. However, other suitable shapes such as for example, inverted U shapes, inverted W shapes, M shapes, or the like can be used.

In the present embodiment, the protrusion structures of the connecting member 350 may be integrally formed with the bottom face 302 of the receiving container 300. The protrusion structures of the connecting member 350 are extended from an inside of the bottom face 302 toward an outside of the bottom face 302.

A distance between the protrusion structures of the connecting member 350 may be substantially equal to or smaller than the interval between the first side face 410 and the second side face 420 of the fixing member 400. When the fixing member 400 is placed between the protrusion structures, the friction between the fixing member 400 and the protrusion structures 350 keeps the fixing member 400 in position.

According to present embodiment, the connecting member 350 having the protrusion structures is disposed on the bottom face 302 of the receiving container 300. Therefore, the fixing member 400 will not separate from the bottom face 302 of the receiving container 300 and particles or impurities will not enter into the receiving container 300 through the bottom face 302.

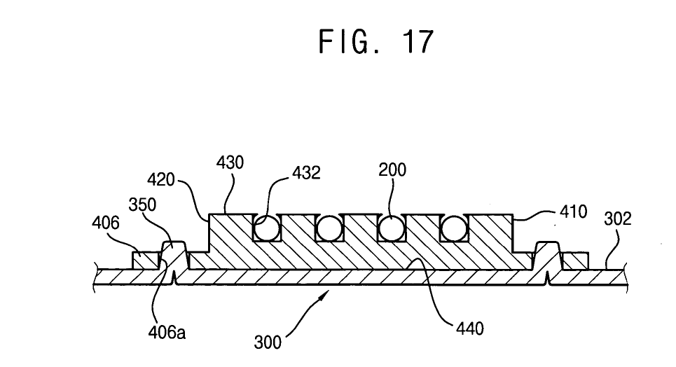

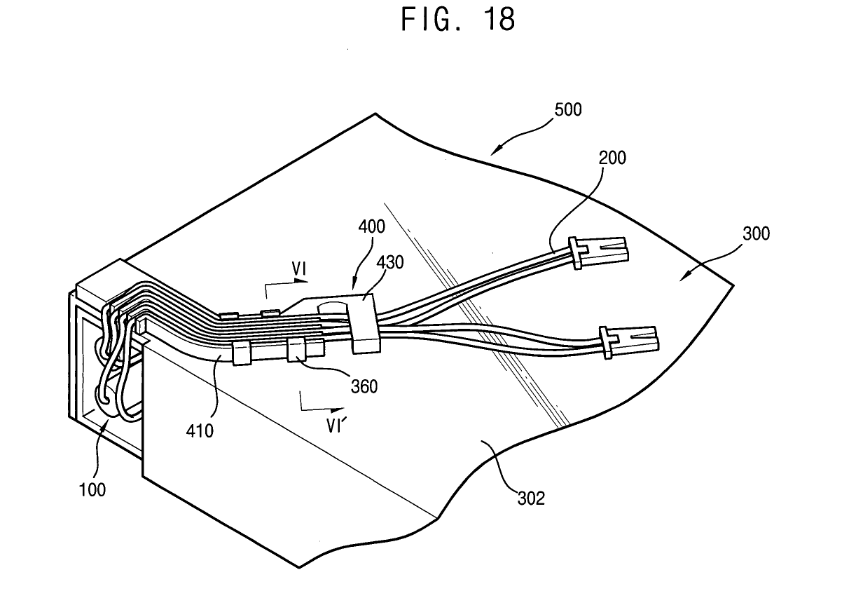

FIG. 16 is a perspective view illustrating another exemplary embodiment of a back light assembly in accordance with the present invention. FIG. 17 is a cross-sectional view illustrating a fixing member and a connecting member taken along line V-V′ in FIG. 16. The back light assembly of the present embodiment has a construction substantially similar to that of the back light assembly according to the first embodiment except for the presence of a connecting member 350 and a fixing member 400.

Referring to FIGS. 16 and 17, the fixing member 400 is disposed on the rear face of the receiving container 300. The fixing member 400 attaches the power supply line 200 on the rear face of the receiving container 300. The power supply line 200 is electrically connected to the light source 100.

As noted above, the fixing member 400 may a synthetic resin and have a substantially rectangular structure. The fixing member 400 comprises the first face 440, the second face 430, the first side face 410 and the second side face 420. The first face 440 makes contact with the rear face of the receiving container 300. The second face 430 is substantially opposed to the first face 440. The first and second side faces 410 and 420 connect the first face 440 to the second face 430.

At least one fixing protrusion 406 protrudes from the first side face 410 and/or the second side face 420 of the fixing member 400. For example, in the FIG. 17, two fixing protrusions 406 protrude from the first side face 410 and the second side face 420, respectively. The fixing protrusion 406 may have a substantially plate-like shape. In one embodiment, the fixing protrusion 406 may have a thickness that is substantially thinner than the thickness of the first side face 410 or that of the second side face 420. The fixing protrusion 406 has an opening 406a or a hole through which the bottom face 302 of the receiving container 300 is visible. The connecting member 350 having a protrusion structure is disposed on the bottom face 302 of the receiving container 300. The protrusion structure of the connecting member 350 protrudes from the inside of the bottom face 302 towards the outside of the bottom face 302. The connecting member 350 is inserted into the opening 406a such that the protrusion structure of the connecting member 350 lies inside the opening 406a of the fixing protrusion 406. Friction between the protrusion structure of the connecting member 350 lies inside the opening 406 of a fixing protrusion 406.

The protrusion structure of the connecting member 350 and the opening 406a of the fixing member 400 are coupled to each other so that the fixing member 400 is firmly coupled to the bottom face 302. Additionally, the power supply line 200 may be firmly fixed to the fixing member 400.

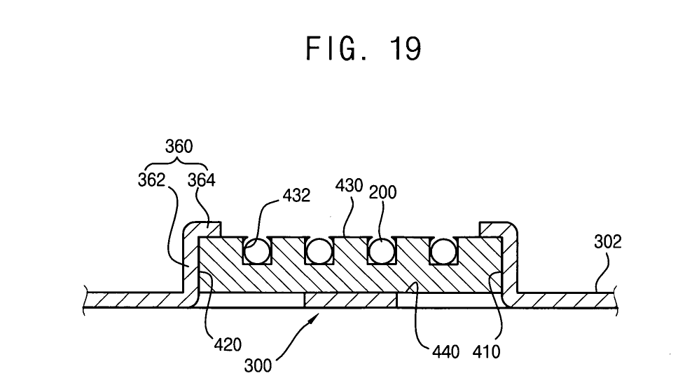

FIG. 18 is a perspective view illustrating another exemplary embodiment of a back light assembly in accordance with the present invention. FIG. 19 is a cross-sectional view illustrating a fixing member and a connecting member taken along line VI-VI′ in FIG. 18. The back light assembly of the present embodiment has a construction substantially similar to that of the back light assembly according to the first embodiment except for the presence of a connecting member 360.

Referring to FIGS. 18 and 19, the fixing member 400 is disposed on the bottom face 302 of the receiving container 300 so as to fix the power supply line 200 to the rear face of the receiving container 300. The connecting member 360 fixes the fixing member 400 to the bottom face 302 of the receiving container 300.

The connecting member 360 includes a first fixing portion 362 and a second fixing portion 364. A portion of the bottom face 302 is cut to thereby form the first fixing portion 362. The second fixing portion 364 is formed by partially bending the fixing portion 362. The first fixing portion 362 of the connecting member 360 is substantially opposed to a first side face 410 and/or a second side face 420 of the fixing member 400. The first fixing portion 362 fixes the first side face 410 and/or the second side face 420 of the fixing member 400 to the bottom face 302. The second fixing portion 364 grips the second face 430 and/or the first side face 410 of the fixing member 400.

In the present embodiment, any horizontal movement of the fixing member 400 towards the left or the right along the bottom face 302 is confined by the first and the second fixing portions 362 and 364. Additionally, any vertical movement of the fixing member 400 relative to the bottom face 302 is also restricted by the first and the second fixing portions 362 and 364.

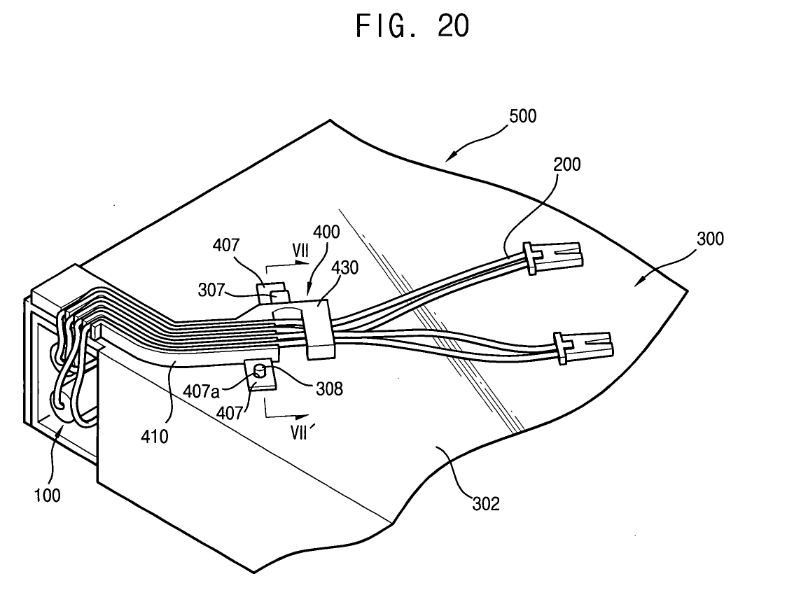

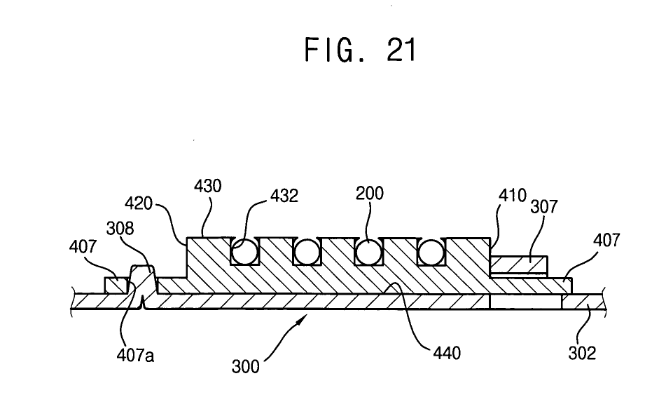

FIG. 20 is a perspective view illustrating another exemplary embodiment of a back light assembly in accordance with the present invention. FIG. 21 is a cross-sectional view illustrating a fixing member and a connecting member taken along line VII-VII′ in FIG. 20. The back light assembly of the present embodiment has a construction substantially similar to that of the back light assembly according to the first embodiment except for the presence of a connecting member and a fixing member 400.

Referring to FIGS. 20 and 21, the fixing member 400 is disposed on a bottom face 302 of a receiving container 300. As noted above, the fixing member 400 may have a substantially rectangular structure. The fixing member 400 includes the first side face 410, the second side face 420, the first face 440 and the second face 430. The second side face 420 is substantially opposed to the first side face 410. The first face 440 makes contact with the bottom face 302 of the receiving container 300. The second face 430 is substantially opposed to the first face 440.

The fixing member 400 includes two fixing protrusions 407 protruded from the first side face 410 and the second side face 420, respectively. The fixing protrusions 407 protrude from the first side face 410 and the second side face 420 and are substantially parallel to the bottom face 302 of the receiving container 300.

In the present embodiment, a hole 407a is formed through one of the fixing protrusions 407 that protrudes from the first side face 410. Alternatively, the hole 407a may be formed through another of the fixing protrusions 407 that protrudes from the second side face 420.

The connecting member includes a bracket structure 307 and a protrusion structure 308. The bracket structure 307 and the protrusion structure 308 are disposed on the bottom face 302 of the receiving container 300. The bracket structure 307 of the connecting member may be used to fix the fixing protrusion 407 that protrudes from the first side face 410 of the fixing member. The bracket structure 307 of the connecting member is formed by cutting and bending a portion of the bottom face 302. The protrusion structure 308 of the connecting member protrudes from the bottom face 302 of the receiving container 300. The protrusion structure 308 of the connecting member may be used to fix the fixing protrusion 407 that protrudes from the second side face 420.

The connecting members including the bracket and the protrusion structures 307 and 308 are thus coupled to the fixing protrusions 407 of the fixing member 400 so that the fixing member 400 may be firmly attached to the bottom face 302 of the receiving container 300. The power supply line 200 may also be firmly coupled to the fixing member 400.

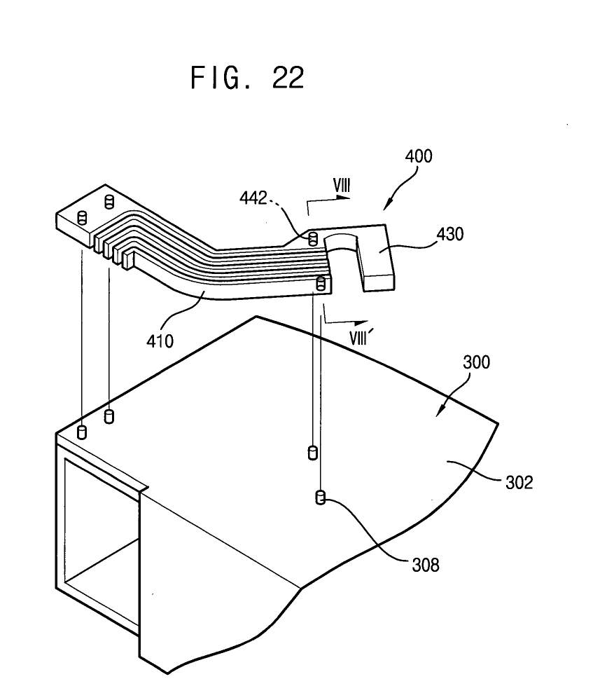

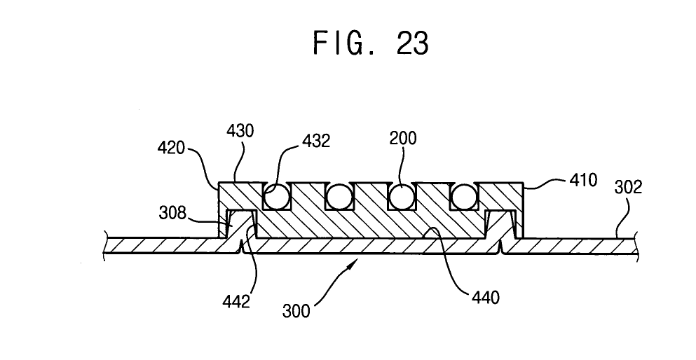

FIG. 22 is an exploded perspective view illustrating another exemplary embodiment of a back light assembly in accordance with the present invention. FIG. 23 is a cross-sectional view illustrating an assembled back light assembly in accordance with the eleventh embodiment of the present invention. The back light assembly of the present embodiment has a construction substantially similar to that of the back light assembly according to the first embodiment except for the presence of a connecting member and the fixing member 400.

Referring to FIGS. 22 and FIG. 23, the connecting member includes protrusion structures 308 disposed on the bottom face 302 of the receiving container 300. The protrusion structures 308 of the connecting member are protruded from the inside of the bottom face 302 toward the outside of the bottom face 302. In the present embodiment, the connecting member includes two protrusion structures 308 that protrude from the bottom face 302 of the receiving container 300. Alternatively, the connecting member may include four protrusion structures 308 that protrude from the bottom face 302 of the receiving container 300. In one embodiment, three protrusion structures 308 protrude from the bottom face 302 of the receiving container 300. In another embodiment, four or more protrusion structures 308 protrude from the bottom face 302 of the receiving container 300. The protrusions can be advantageously located on any portion of the bottom face 302 of the receiving container.

The fixing member 400 has openings 442 corresponding to the protrusion structures 308 of the connecting member, respectively. Alternatively, the fixing member 400 may have recesses or grooves corresponding to the protrusion structures 308 of the connecting member.

Since the fixing member 400 includes openings 442 and the connecting member includes protrusion structures 308 formed on the bottom face 302 of the receiving container 300, the fixing member 400 and the connecting member may be firmly attached to each other. Alternatively, the connecting member may include openings through the bottom face 302 and the fixing member 400 may include fixing protrusions 308 so that the fixing member 400 and the connecting member may be firmly attached to each other.

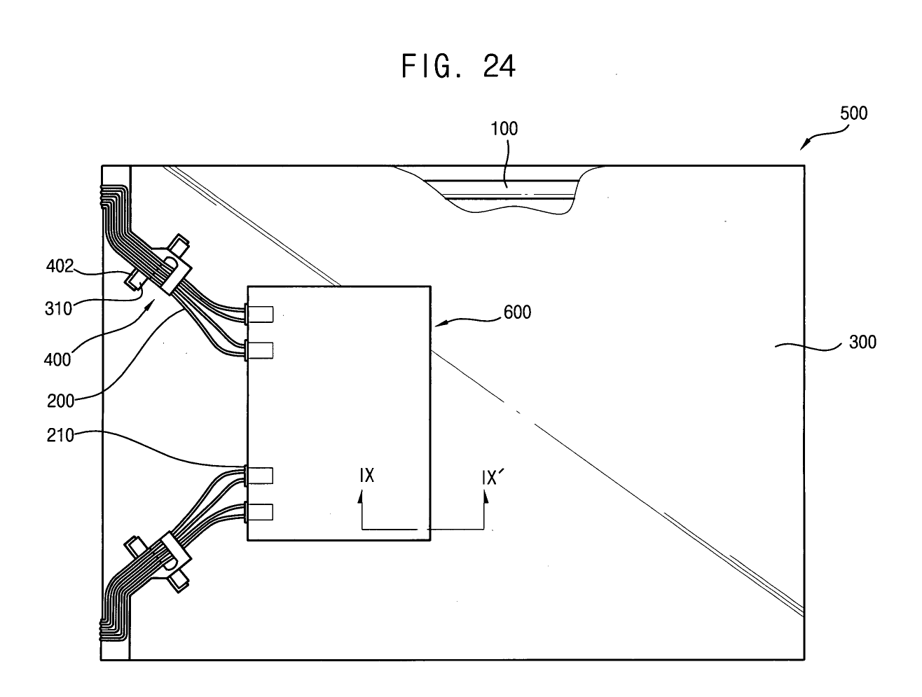

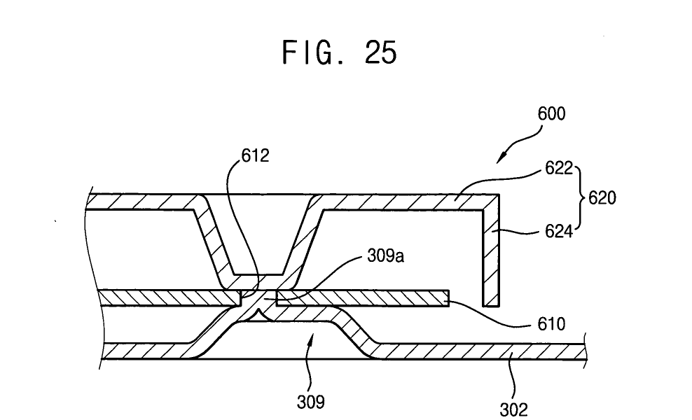

FIG. 24 is a rear plan view illustrating another exemplary embodiment of a back light assembly in accordance with the present invention. FIG. 25 is a cross-sectional view illustrating an assembled back light assembly in accordance with the present invention. The back light assembly of the present embodiment has a construction substantially similar to that of the back light assembly according to the first embodiment except for the presence of an inverter module 600.

Referring to FIGS. 24 and 25, the inverter module 600 is disposed on the bottom face 302 of the receiving container 300. The inverter module 600 is electrically connected to a power supply line 200 through a connector 210 combined with the power supply line 200. The inverter module 600 supplies the electrical power to the light source through the power supply line 200 so that the light source 100 generates a light.

The inverter module 600 includes an inverter 610 and a shield case 620. The inverter 610 inverts a direct current to an alternating current. The inverter 610 has a shape substantially similar to that of a printed circuit board. In addition, at least two bosses 309 protrude from the bottom face 302 corresponding to the inverter 610 so that any electrical connectivity between the inverter 610 and the bottom face 302 may be prevented. The inverter 610 and the bottom face 302 are separated from each other by interposing bosses 309. Further, a coupling protrusion 309a is provided on an upper face of the boss 309. The coupling protrusion 309a more firmly fixes the inverter 610 to the bottom face 302. The inverter 610 further includes a through hole 612. The coupling protrusion 309a is inserted into the through hole 612 of the inverted 610.

While the inverter 610 generates a voltage that is applied to the light source 100, a large amount of electromagnetic energy in the form of electromagnetic waves are generated from the inverter 610. The shield case 620 includes a bottom face 622 and a sidewall 624 connected to the bottom face 622. The shield case 620 covers the inverter 610 in order to shield the electromagnetic waves generated from the parts of the inverter 610. The shield case 620 may convert the electromagnetic waves generated from the inverter 610 into heat.

In the present embodiment, an end portion of the sidewall 624 of the shield case 620 is separated from the bottom face 302. When the sidewall 624 of the shield case 620 is separated from the bottom face 302 of the receiving container 300, the electromagnetic waves generated from the inverter 610 may be considerably reduced.

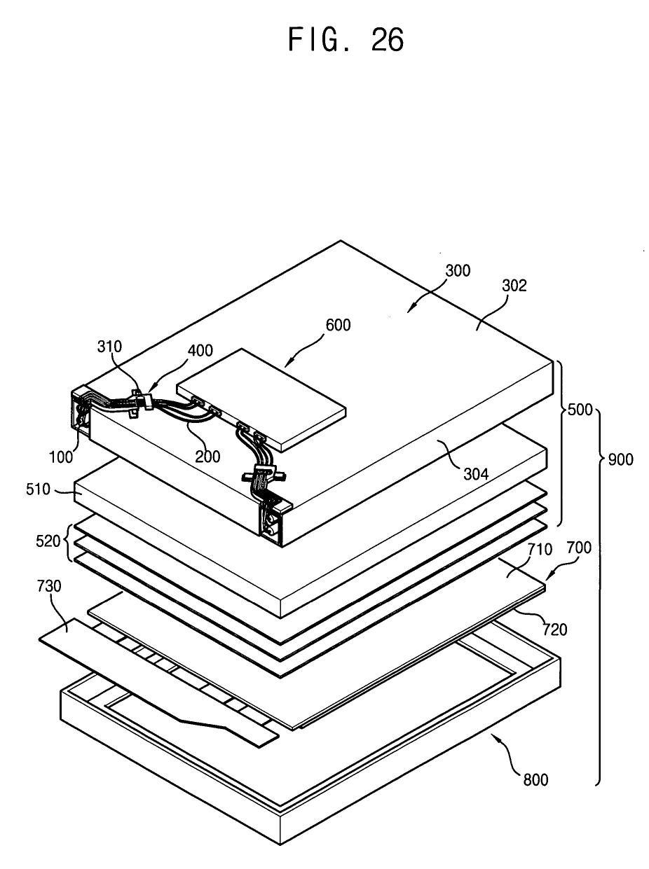

FIG. 26 is an exploded perspective view illustrating an exemplary embodiment of a display device in accordance with a thirteenth embodiment of the present invention. The display device of the present embodiment includes a back light assembly substantially similar to that of the embodiment in FIG. 1.

Referring to FIG. 26, a display device 900 includes a back light assembly 500, a display panel 700 and a top chassis 800.

The back light assembly 500 includes a receiving container 300, a light source 100, an inverter module 600, a power supply line 200, a fixing member 400 and a connecting member 310.

The receiving container 300 receives the light source 100. The inverter module 600 supplies electrical power to the light source 100. The power supply line 200 transmits the power provided from the inverter module 600 into the light source 100. The fixing member 400 fixes the power supply line 200 to the receiving container 300. The connecting member 310 fixes the fixing member 400 to the receiving container 300.

The back light assembly 500 further includes a light guiding plate 510 and optical sheets 520. The light guiding plate 510 may improve the optical distribution of light generated from the light source 100. The optical sheets 520 may improve optical characteristics of the light transmitted from the light guiding plate 510.

The display panel 700 includes a thin film transistor substrate 710, a liquid crystal layer (not shown), a color filter substrate 720 and a printed circuit board 730.

A plurality of pixels may be disposed on the thin film transistor substrate 710 in a matrix shape. At least one thin film transistor is disposed on the pixels. The thin film transistor applies a driving signal generated from the printed circuit board 730 to the pixels. The color filter substrate 720 may include a common electrode and a color filter corresponding to the pixels. The common electrode may be substantially opposed to the pixels.

The liquid crystal layer may be disposed between the color filter substrate 720 and the thin film transistor substrate 710. When an electric field difference between the pixels and the common electrode occurs, the alignment of the liquid crystals in the liquid crystal layer may vary. Thus, the light transmittance of the liquid crystal layer may be varied by changing the applied electric field.

According to the present invention, a power supply line may be firmly fixed to a rear face of the receiving container by employing the fixing member and the connecting member so that damage or breakage of the power supply line may be effectively prevented. Additionally, the power supply line may be easily attached to the receiving container without any shorting of the power supply line or any damage to the power supply line.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

What is claimed is:

1. A back light assembly comprising:
a light source to generate light;
a power supply line that supplies power to the light source;
a receiving container that receives the light source, the receiving container comprising a bottom face;
a fixing member that attaches the power supply line to the receiving container; and
a connecting member disposed on the receiving container to couple the fixing member to a rear face of the receiving container.

2. The back light assembly of claim 1, wherein the fixing member comprises at least one fixing protrusion that protrudes from at least one side face of the fixing member, the protrusion being coupled to the connecting member to fix the fixing member to the receiving container.

3. The back light assembly of claim 2, wherein the connecting member comprises a bracket structure to receive the fixing protrusion, the bracket structure being formed by cutting a portion of the bottom face of the receiving container corresponding to the fixing protrusion.

4. The back light assembly of claim 3, wherein the connecting member comprises a first fixing portion and a second fixing portion extended from the first fixing portion, the first fixing portion being substantially perpendicular to the rear face of the receiving container, the second fixing portion substantially facing the fixing protrusion.

5. The back light assembly of claim 4, wherein an angle between the second fixing portion of the connecting member and the rear face of the receiving container is substantially smaller than a right angle.

6. The back light assembly of claim 5, wherein the angle is in the range of about 45° to about 85°.

7. The back light assembly of claim 4, wherein the second fixing portion comprises a protruding portion that protrudes toward the fixing protrusion, and the fixing protrusion has an opening that corresponds to the protruding portion of the second fixing portion, and further wherein the coupling of the fixing member to a rear face of the receiving container is accomplished by inserting the protruding portion into the opening.

8. The back light assembly of claim 4, wherein the second fixing portion has an opening and the fixing protrusion comprises a protruding portion that corresponds to the opening of the second fixing portion, and further wherein the coupling of the fixing member to a rear face of the receiving container is accomplished by inserting the protruding portion into the opening.

9. The back light assembly of claim 4, wherein the fixing protrusion comprises a rib to prevent the second fixing portion from being separated from the fixing protrusion.

10. The back light assembly of claim 4, wherein the rear face of the receiving container comprises an opening, and an area of the fixing protrusion is substantially larger than that of the opening on the rear face so as to cover the opening of the rear face.

11. The back light assembly of claim 3, wherein the fixing member comprises two fixing protrusions, one fixing protrusion being protruded from a first side face of the fixing member, the other fixing protrusion being protruded from a second side face of the fixing member, and wherein the connecting member comprises two bracket structures that receive the fixing protrusions, respectively.

12. The back light assembly of claim 1, wherein the fixing member has an engaging recess and the bottom face has a first hole so that the fixing member and the rear face of the receiving container are attached to each other using a screw inserted into the engaging recess through the first hole.

13. The back light assembly of claim 12, wherein the light source comprises a cover having a second hole corresponding to the first hole so that the cover is coupled to the bottom face using the screw passing through the second hole.

14. The back light assembly of claim 1, wherein the fixing member comprises a first face and a second face, the first face making contact with the rear face of the receiving container, the second face being substantially opposed to the first face, and wherein the second face has at least one fixing groove to attach the power supply line to the receiving container.

15. The back light assembly of claim 14, wherein the fixing member comprises a separation preventing protrusion to prevent the power supply line from being separated from the fixing groove, and wherein the separation preventing protrusion protrudes from an inside of the fixing groove.

16. The back light assembly of claim 1, wherein the connecting member comprises at least one protrusion structure to attach the fixing member to the receiving container, and wherein a protrusion structure protrudes from the rear face of the receiving container.

17. The back light assembly of claim 16, wherein the connecting member comprises a pair of protrusion structures that protrude from the rear face of the receiving container, the protrusion structures making contact with both of the side faces of the fixing member.

18. The back light assembly of claim 16, wherein the fixing member has a fixing protrusion that protrudes from the side face of the fixing member, the fixing protrusion substantially facing the protrusion structure, and wherein the fixing protrusion has an opening that corresponds to the protrusion structure.

19. The back light assembly of claim 1, wherein the connecting member comprises a first fixing portion and a second fixing portion, the first fixing portion being formed by cutting a portion of the rear face of the receiving container, the second fixing portion being formed by bending the cut portion of the rear face of the receiving container so as to grip the fixing member.

20. The back light assembly of claim 19, wherein the connecting member comprises two bracket structures disposed on corresponding side faces of the fixing member.

21. The back light assembly of claim 19, wherein the connecting member comprises two protrusion structures disposed on corresponding side faces of the fixing member.

22. The back light assembly of claim 1, wherein the fixing member comprises two fixing protrusions that protrude from corresponding sidewalls of the fixing member, and wherein the connecting member comprises a bracket structure and a protrusion structure, and further wherein one fixing protrusion is coupled to the bracket structure formed by cutting a portion of the rear face of the receiving container, and the other fixing protrusion has an opening that is coupled to the protrusion structure.

23. The back light assembly of claim 1, wherein the rear face of the receiving container comprises a coupling protrusion, and the fixing member has an opening corresponding to the coupling protrusion of the rear face of the receiving container.

24. The back light assembly of claim 1, wherein the rear face of the receiving container has an opening, and the fixing member comprises a coupling protrusion corresponding to the opening in the rear face of the receiving container.

25. The back light assembly of claim 1, wherein the receiving container comprises an inverter module including an inverter to apply power to the power supply line.

26. The back light assembly of claim 25, wherein the rear face of the receiving container comprises at least one boss to separate the inverter module from the rear face of the receiving container.

27. The back light assembly of claim 26, wherein the boss comprises a protrusion to fix the inverter module to the bottom face of the receiving container, and wherein the inverter module has an opening corresponding to the protrusion of the boss.

28. The back light assembly of claim 25, wherein the inverter module further comprises a shield case to absorb an electromagnetic wave generated from the inverter module.

29. The back light assembly of claim 28, wherein the shield case comprises a bottom face and a sidewall, the bottom face of the shield case substantially facing the bottom face of the receiving container, the sidewall of the shield case being disposed on a peripheral portion of the bottom face of the shield case and being substantially perpendicular to the bottom face of the receiving container, and wherein an end portion of the sidewall of the shield case is separated from the bottom face of the receiving container, the end portion of the sidewall of the shield case substantially facing the bottom face of the receiving container.

30. A display device comprising:
a back light assembly comprising a light source to generate a light;
a power supply line that supplies power to the light source;
a receiving container having a bottom face to receive the light source;
a fixing member that attaches the power supply line to the receiving container;
a connecting member disposed on the receiving container to couple the fixing member to a rear face of the receiving container; and
a display panel received in the receiving container to display images using the light.

31. The display device of claim 30, wherein the fixing member comprises at least one fixing protrusion protruded from at least one side face of the fixing member, wherein the fixing protrusion contacts the rear face of the receiving container.

32. The display device of claim 31, wherein the connecting member comprises a bracket structure to receive the fixing protrusion, the bracket structure being formed by cutting a portion of the bottom face of the receiving container corresponding to the fixing protrusion.

33. The display device of claim 32, wherein the connecting member comprises a first fixing portion and a second fixing portion extended from the first fixing portion, the first fixing portion being substantially perpendicular to the rear face of the receiving container, the second fixing portion substantially facing the fixing protrusion.

34. The display device of claim 33, wherein an angle between the second fixing portion and the rear face of the receiving container is substantially smaller than a right angle.

35. The display device of claim 34, wherein the angle is in the range of about 45° to about 85°.

36. The display device of claim 33, wherein the second fixing portion comprises a protruding portion protruded toward the fixing protrusion and the fixing protrusion has an opening corresponding to the protruding portion of the second fixing portion.

37. The display device of claim 33, wherein the second fixing portion has an opening and the fixing protrusion comprises a protruding portion corresponding to the opening of the second fixing portion.

38. The display device of claim 33, wherein the fixing protrusion comprises a rib to prevent the second fixing portion from being separated from the fixing protrusion.

39. The display device of claim 33, wherein the rear face of the receiving container has an opening, and an area of the fixing protrusion is substantially larger than that of the opening to cover the opening of the rear face of the receiving container.

40. The display device of claim 32, wherein the fixing member comprises two fixing protrusions, one fixing protrusion that protrudes from a first side face of the fixing member, the other fixing protrusion protruding from a second side face of the fixing member, and wherein the connecting member comprises two bracket structures to receive the fixing protrusions.

41. The display device of claim 30, wherein the fixing member comprises a first hole and the rear face of the receiving container has a second hole corresponding to the first hole so that the fixing member and the rear face of the receiving container are coupled to each other using a screw passing through the first and the second holes.

42. The display device of claim 41, the light source comprises a cover having a third hole corresponding to the first through hole so that the cover is coupled to the bottom face using the screw passing through the third hole.

43. The display device of claim 30, wherein the connecting member comprises at least one protrusion structure to fix the fixing member to the receiving container, the protrusion structure being protruded from the bottom face of the receiving container.

44. The display device of claim 43, wherein the connecting member comprises a pair of the protrusion structures disposed on both side faces of the fixing member.

45. The display device of claim 43, wherein the fixing member comprises a fixing protrusion protruded from the side face of the fixing member, and wherein the fixing protrusion has an opening corresponding to the protrusion structure.

46. The display device of claim 30, wherein the fixing member comprises a synthetic resin.

47. The display device of claim 30, wherein the synthetic resin is a thermoplastic resin or a thermosetting resin.

48. The display device of claim 47, wherein the thermoplastic resin is a polyolefin, a polyamide, a polycarbonate, a polyester, a polyimide, a polyacrylate, a polymethacrylate, a polyurethane or a combination comprising at least one of the foregoing thermoplastic resins.

49. The display device of claim 47, wherein the thermosetting resin is a polysiloxane, an epoxy, a phenolic resin, a polyurethane or a combination comprising at least one of the foregoing thermosetting resins.

50. The display device of claim 46, wherein the synthetic resin further comprises glass fibers, carbon fibers, nanotubes, titanium dioxide, mica, clay or a combination comprising at least one of the foregoing fillers.
